(19) United States
(12) Patent Application Publication
(10) Pub. No.: US 2021/0264069 A1
(43) Pub. Date: Aug. 26, 2021

(54) SYSTEM, COMPUTER-AIDED METHOD AND COMPUTER PROGRAM PRODUCT FOR GENERATING STRUCTURAL PARAMETERS OF A COMPLEX APPARATUS

(71) Applicant: Siemens Aktiengesellschaft, München (DE)

(72) Inventors: Thomas Baudisch, Schondorf am Ammersee, Bayern (DE); Harald Ertl, Schwanstetten (DE); Andreas Garhammer, Reut (DE); Yiqing Guo, Nürnberg (DE); Denis Smirnov, München (DE); Andreas Utz, Blaufelden (DE)

(21) Appl. No.: 17/252,333

(22) PCT Filed: Jun. 7, 2019
(86) PCT No.: PCT/EP2019/064992

§ 371 Date: Dec. 15, 2020

(30) Foreign Application Priority Data
Jun. 18, 2018 (EP) 18178202.0

(51) Int. Cl. G06F 30/10; G06F 30/27; G06N 3/08

(52) U.S. Cl. CPC G06F 30/10; G06N 3/08; G06F 30/27

(57) ABSTRACT

A computer-aided method, based on at least one specification parameter, construction parameters are generated by a complex device by a trained neural network is provided. The neural network is trained based on reference data and operating data, wherein a non-insignificant part of the data is used for training from the iteration steps of the specialist. The reference data characterizes a plurality of complex devices which have been constructed or produced in the past and their respective at least one specification parameter and construction parameters thereof. The operating data characterizes the plurality of complex devices and their respective operating parameters which correspond to the respective construction parameters.

### CROSS-REFERENCE TO RELATED APPLICATIONS

This application claims priority to PCT Application No. PCT/EP2019/064992, having a filing date of Jun. 07, 2019, which is based on EP Application No. 18178202.0, having a filing date of Jun. 18, 2018, the entire contents both of which are hereby incorporated by reference.

### FIELD OF TECHNOLOGY

The following concerns the field of designing complex apparatuses and applicable design tools and relates to a system for generating structural parameters of a complex apparatus from at least one specification parameter, to a corresponding computer-aided method and to a corresponding computer program product.

### BACKGROUND

When designing/developing complex apparatuses it is normally necessary to comply with one or more specification parameters. Such specification parameters are typically obtained from the description of a product required by a customer or of a required complex apparatus and from the demands on the complex apparatus during its operation.

During a conventional design process—that is to say the designing and/or constructing of a complex apparatus of this kind and the requisite determining of structural parameters of this complex apparatus—a person skilled in the art in the respective field of expertise for the respective complex apparatus determines an initial design on the basis of the expert know-how of this person skilled in the art and from the specification parameters. The design of this complex apparatus, i.e. its structural parameters, is then optimized until the specification parameters are complied with. The specification parameters correspond to operating parameters of the complex apparatus, such a specification parameter being able to be dependent on one or more operating parameters, i.e. such a specification parameter is complied with when one or more specific operating parameters are each in a specific value range. For example the maximum electric power loss for an electrical component may be stipulated as a specification parameter, this being complied with when the current draw and the voltage i.e.—the voltage drop across the electrical component—are each below a specific limit value during operation.

A conventional design process may also require the design process to be performed again with a different initial design, if the specification parameters could not be reached in a first pass of the design process.

A conventional design process often requires many passes with different initial designs and/or many steps for optimizing the structural parameters. The final design in this instance, i.e. the structural parameters of the complex apparatus, may also be—even substantially—dependent on the initial design. A conventional design process of this kind may thus be resource intensive and/or the result respectively attained, i.e. the structural parameters finally determined by the designing person skilled in the art, may be dependent on the respective person skilled in the art.

Different designs, i.e. structural parameters, for the complex apparatus may thus result, when the requirements of a customer are identical. A design process that is common today may also be time consuming on—account of the many iterations for optimizing the structural parameters.

### SUMMARY

An aspect relates to facilitating the designing of a complex apparatus and/or of improving the structure of a complex apparatus and of making the determining of structural parameters of a complex apparatus more efficient and/or of harmonizing a structure of a complex apparatus of this kind constructed on the basis of structural parameters determined in this manner.

Embodiments of the invention achieve this aspect in each case by a computer-aided method for generating structural parameters of a complex apparatus from at least one specification parameter, by a system for generating structural parameters of a complex apparatus from at least one specification parameter and by a computer program product (non-transitory computer readable storage medium having instructions, which when executed by a processor, perform actions) for generating structural parameters of a complex apparatus from at least one specification parameter, each time according to the teaching of one of the main claims. Advantageous embodiments, developments and variants of the present invention are the subject of the subclaims.

A first aspect of embodiments of the invention relates to a computer-aided method for generating structural parameters of a complex apparatus from at least one specification parameter by a neural network. The method comprises the following: the method involves reference data—in some variants for example historical designs, a chronology of work steps and/or certainly by a sensitivity analysis on the basis of artificially generated input parameters—being provided that denote a multiplicity of complex apparatuses and the respective at least one specification parameter thereof and also in each case structural parameters. The method involves operating data being provided that denote the multiplicity of complex apparatuses and the respective operating parameters thereof that correspond to the respective structural parameters. Moreover, the method involves the neural network being trained on the basis of the reference data and the operating data. Finally, the structural parameters of the complex apparatus are generated from the at least one specification parameter and by the trained neural network.

Some variants of embodiments of the invention are used when input parameters lead to a specific product with desired operating parameters by dedicated and complex software.

Advantageous uses and accordingly designed variants thereof may be:
transformers: suitable input parameters and initial configuration such as winding arrangement and winding types, etc., lead, by complex software (analysis and verification), to a specific design that needs to meet customer requirements such as losses, noise, etc.;
driving gear;
gas turbines; and
distillation columns for the chemical industry.

A “structural parameter” within the context of embodiments of the invention is intended to be understood to mean at least data that characterize and/or determine the embodiment of at least one part of a complex apparatus—by numerical values. As such, in particular the physical dimensions of a complex apparatus may be characterized and determined by one or more structural parameters—for example the overall height, width and/or length of a complex apparatus of this kind as a result of the indication of the values of its respective extent in a measure of length such as meters or inches. The material properties and/or the materials used may also be determined by one or more structural parameters—for example the material of a cable of a complex apparatus of this kind as a result of the indication of a numerical value or text coding the respective material—for example “copper”, “Cu” for copper or any numerical identifier. Structural parameters determined on the basis of the application, in particular what are known as design parameters, may also be particularly relevant.

As such, design parameters of transformers are in particular:
varied parameters:
   core diameter
   electromagnetic steel grade
   winding arrangements
   numbers of turns
   number of parallel conductors in windings
   number of subconductors in a conductor
   current densities
   number of layers or coils in windings
   cooling equipment
target variables:
   geometric data:
      max. dimensions
      max. weights
   operating data:
      short-circuit impedance
      max. losses
      max. noise
   minimal costs

An “operating parameter” within the context of embodiments of the invention is intended to be understood to mean at least data that characterize at least one part of a complex apparatus during its operation and/or the operation of the complex apparatus. Such operating parameters are dependent in particular on one or more structural parameters and/or may correspond thereto. As such, for example the physical dimensions of a complex apparatus of this kind may also be operating parameters. Moreover, performance values, the occurrence of faults and/or numerical values that characterize the operation of a complex apparatus or of its components may be operating parameters.

A “complex apparatus” within the context of embodiments of the invention is intended to be understood to mean at least one apparatus that has multiple structural parameters and operating parameters, and a relationship between the structural parameters and the operating parameters is so complex that, at least given generally selected values or data for the structural parameters, it is not possible to indicate a general functional—in particular mathematical—relationship. Some complex apparatuses of this kind may be describable by high-dimensional differential equations, which have no stable solutions, or have them only for limited value ranges, on account of their high dimensionality and the complex relationships between the structural parameters and the operating parameters, however.

A “neural network” within the context of embodiments of the invention is intended to be understood to mean at least one artificial neural network. A neural network of this kind can have in particular an adaptable transformation of input values to output values, the transformation being able to be effected via one or more intermediate levels—known as layers of the neural network. For the purposes of adapting, the neural network can be trained in particular using data for the input values and possibly associated data for the output values, this normally being effected as what is known as “supervised learning”. In particular, an artificial neural network of this kind may be implemented electronically and/or digitally.

An advantage of generating the structural parameters of the complex apparatus by the trained neural network may be in particular that the structural parameters determined in this manner and hence the design of the complex apparatus can be determined reproducibly—and in particular independently of a respective person skilled in the art—which means that the structure of a complex apparatus of this kind can be harmonized. In particular such harmonization allows designs of complex apparatuses and hence structures of complex apparatuses to be provided and/or produced with constant quality and/or with the same type of respective design on the basis of the respective structural parameters. It is therefore also possible to attain in particular a higher degree of compatibility between multiple complex apparatuses constructed in this manner i.e. using structural parameters generated in this manner. An advantage of training the neural network on the basis of both the reference data and the operating data may also be in particular that both a relationship between specification parameters and possible solutions for these specification parameters, i.e. the respective structural parameters, and the operating parameters resulting from the respective structural parameters can be trained, which allows in particular more efficient training and/or faster convergence of the neural network.

It is also possible in this advantageous manner—in particular in the case of complex apparatuses for which an expert needs to perform a multiplicity of design iterations in order to find suitable structural parameters—for the absolute/total time needed for generating/finding the structural parameters to be reduced. As such, for example with sufficient processing power, a suitable or the optimum solution for the respective structural parameters can be found within a few seconds. In particular, one difficulty with the (manual) design of a complex apparatus of this kind such as a transformer may be in particular that highly nonlinear functions such as e.g. a cost function must nevertheless lead to discrete values such as e.g. the number of turns. An advantage of the neural network in this case may be in particular that it can also be trained and/or outputs a suitable solution for highly nonlinear functions of this kind.

In some advantageous embodiments, the method furthermore involves manual design iterations of at least one complex apparatus from the multiplicity of complex apparatuses for reaching the at least one specification parameter of this at least one complex apparatus being monitored. Moreover, the method involves the reference data being adapted, wherein the structural parameters for this at least one complex apparatus are stored for every manual design iteration. In addition, the method involves the operating data being adapted, wherein the operating parameters for this at least one complex apparatus are stored for every manual design iteration. The neural network is trained on the basis of these adapted reference data and operating data. In this advantageous manner, the neural network can be trained not only on the basis of (final) structural parameters for the complex apparatuses from the multiplicity of complex apparatuses but also on the basis of the structural parameters for the at least one complex apparatus that have been—in particular input by a person skilled in the art and—used for every manual design iteration, in order to reach the at least one specification parameter for the at least one complex apparatus. It also becomes possible to train the neural network using the respective operating parameters that correspond to the structural parameters for the respective design iteration, which means that during the training of the neural network is provided with a stipulation regarding a way of designing the at least one complex apparatus and the success or failure of the individual manual design iterations—that is to say the extent to which the at least one complex apparatus is consistent with the at least one specification parameter on the basis of its respective operating parameters for every design iteration. This allows in particular better and/or faster convergence to be achieved during the training of the neural network. An advantage of training using the adapted reference data and operating data that denote the structural parameters and corresponding operating parameters for every design iteration may also be in particular that the structural parameters generated by the neural network converge with such structural parameters that an applicable person skilled in the art would determine and/or the structural parameters generated by the trained neural network and hence in particular the solution for the design of the complex apparatus become more comprehensible to a person skilled in the art.

In some embodiments, the method furthermore comprises simulating the complex apparatus on the basis of the generated structural parameters to determine operating parameters of the complex apparatus. In such embodiments, the training of the neural network is moreover based on the at least one specification parameter and the operating parameters of the complex apparatus. In this advantageous manner, it becomes possible, during the training of the neural network, to stipulate the quality of the solution of the neural network, that is to say in particular the generating of the structural parameters of the complex apparatus, and also the reaching of the at least one specification parameter via the operating parameters of the complex apparatus that correspond to the generated structural parameters as (further) training data, or in addition to (also) base the training thereon, which allows the training to be improved and in particular better solutions to be generated by a neural network trained in this manner, i.e. the specification parameters are adhered to better according to the operating parameters during operation of the complex apparatus.

In some embodiments in which the complex apparatus is simulated on the basis of the generated structural parameters and the neural network is trained using the operating parameters determined in this manner, the training of the neural network is carried out iteratively while respectively simulating the complex apparatus on the basis of the respectively generated structural parameters. In this advantageous manner, the training of the neural network and hence the trained neural network can be improved further, with in particular the solution for the complex apparatus, that is to say the generated structural parameters, being able to be iteratively optimized further. One advantage may also be in particular that no further—in particular external—data are needed for the further training, that is to say in particular the neural network can be improved further even given constant reference data and operating data.

In some embodiments, the method involves at least one complex apparatus from the multiplicity of complex apparatuses being simulated to determine its operating parameters for providing or adapting the operating data. An advantage of simulating this at least one complex apparatus may be in particular that the simulation allows the operating parameters to be determined efficiently and/or with a lower resource requirement than for example when building a prototype.

In some embodiments, the complex apparatus or at least one complex apparatus from the multiplicity of complex apparatuses is simulated by a simulation program. In this advantageous manner, the operating parameters of the complex apparatus or of the at least one complex apparatus can be determined by a computer containing such a simulation program, the quality when determining the operating parameters—that is to say the extent to which the simulated operating parameters are consistent with the actual operating parameters during actual operation—normally being able to be increased by using appropriate simulation programs and/or by increased processing power. It also becomes possible to determine operating parameters for a multiplicity of complex apparatuses and/or for a multiplicity of design iterations in this advantageous manner, in particular efficiently, inexpensively and/or with little delay.

In some embodiments, the method involves the operating data for at least one complex apparatus from the multiplicity of complex apparatuses being provided by virtue of the operating parameters being received. In this case, reception is accomplished in some advantageous variants by virtue of the operating parameters being sent by a sensor system configured to measure the operating parameters of this at least one complex apparatus.

In some embodiments in which the operating parameters of the at least one complex apparatus are received from a sensor system, the method involves the operating parameters of this at least one complex apparatus being measured by the sensor system.

An advantage of receiving operating parameters measured by the sensor system may be in particular that these operating parameters reflect the actual operating parameters under real operating circumstances. As such, in particular operating parameters of the at least one complex apparatus can be measured and received from a prototype operation, from a field use and/or also from a productive use. As a result, it is possible to take into consideration influencing variables that for example might be ignored or considered only with a high level of outlay in a simulation, such as for example production variations, variations in the materials used in production, interference effects or real operating conditions that are unknown and/or not adequately specified for the complex apparatus in a description by a customer.

In some embodiments, an error magnitude is determined during training of the neural network. The error magnitude in this instance comprises the divergence between the structural parameters of the reference data and structural parameters determined by the neural network.

In some embodiments, an error magnitude is determined during training of the neural network. The error magnitude in this instance comprises the divergence between the respective at least one specification parameter and respective operating parameters that correspond to the structural parameters determined by the neural network.

In some embodiments in which an error magnitude is determined, the error magnitude can comprise a combination of divergences and/or it is possible for the divergences that the error magnitude comprises to be combined with one another—in particular summed to form a weighted total error value.

An advantage of determining the error magnitude may be in particular that the neural network can also be trained on the basis of this error magnitude. It is advantageously possible for multiple criteria for training the neural network using the error magnitude to be combined with one another and merged. It is also possible, in particular when the neural network is trained iteratively, to use the error magnitude for a further iteration of the training. Additionally, determining the error magnitude can allow the success of the training and/or the quality of the structural parameters respectively determined or generated during the training to be quantified by the, in the case of multiple iterations in particular respective, error magnitude, which in particular allows the training to be implemented more efficiently. In some variants that implement a back-propagation algorithm—which in particular is consistent with a gradient descent to find a (local) optimum on a hyperlevel in the solution space for training, the step size can be varied depending on the error magnitude. In some variants, a large step size or a large adaptation for the neural network can be chosen for training if there is a large error—that is to say the determined or generated structural parameters are still highly divergent from a suitable solution—whereas if the error is already small, that is to say the respective solution is already close to the (local) optimum, then a small step size or a small adaptation for the neural network can be chosen, which in particular allows fast and/or exact convergence.

According to some embodiments in which an error magnitude is determined, the reference data for at least one complex apparatus from the multiplicity of complex apparatuses respectively denote structural parameters for every design iteration for multiple design iterations for reaching the at least one specification parameter. Moreover, the operating data for this at least one complex apparatus respectively denote operating parameters for every design iteration, wherein the operating parameters correspond to the structural parameters for this at least one apparatus and for the respective design iteration. In such embodiments, the neural network is moreover configured to respectively determine the structural parameters for multiple design iterations from the at least one specification parameter of this at least one complex apparatus. Additionally, the method involves, in particular during determination of the error magnitude, the divergences between the structural parameters of the reference data and structural parameters determined by the neural network being furthermore determined for every design iteration for this at least one complex apparatus, wherein the error magnitude also comprises these divergences. In this advantageous manner, the neural network can be used to generate structural parameters for multiple design iterations and/or the neural network can be accordingly trained to replicate a—in particular manual design process, as a result of which a solution generated by the neural network, that is to say in particular the structural parameters of the complex apparatus, become comprehensible to a person skilled in the art and/or it becomes possible to specifically train the neural network so that it takes a specific path when generating the structural parameters using multiple design iterations. In particular the comprehensibility can allow a person skilled in the art to adapt and/or optimize the design—i.e. the structural parameters of the complex apparatus—further, which means that the complex apparatus can be improved further and/or further specification parameters can be taken into consideration. In some variants, such adaptation can also be used as part of the reference data for the purposes of structural parameters of a further design iteration for training the neural network.

In some embodiments in which an error magnitude is determined and the reference data for at least one complex apparatus from the multiplicity of complex apparatuses respectively denote structural parameters for every design iteration for multiple design iterations, the method furthermore comprises: simulating the at least one complex apparatus for every design iteration and on the basis of the respective structural parameters to provide its respective operating parameters for providing or adapting the operating data. Moreover, the method involves, in particular during determination of the error magnitude, the divergences between the at least one specification parameter of this at least one complex apparatus and the respective operating parameters for the respective design iteration being furthermore determined for every design iteration for this at least one complex apparatus, wherein the error magnitude also comprises these divergences.

In some embodiments in which an error magnitude is determined, the neural network is configured to generate the structural parameters of the complex apparatus from the at least one specification parameter of the complex apparatus for every design iteration from multiple design iterations. Moreover, the method involves the respective operating parameters of the complex apparatus being simulated for every design iteration. In addition, the method involves, in particular during determination of the error magnitude, the divergences between the at least one specification parameter and the respective operating parameters being furthermore determined for every design iteration, wherein the error magnitude also comprises these divergences. This can result in advantages that are consistent with the advantages of embodiments in which the reference data denote the structural parameters for every design iteration for at least one complex apparatus from the multiplicity of complex apparatuses. It also becomes possible in this advantageous manner to train the neural network on the basis of a series of structural parameters and corresponding operating parameters for the complex apparatus, wherein in particular the error magnitude and/or the training may be configured such that the error is particularly small when the respective operating parameters for the specification parameter converge on a final value over the series. In this advantageous manner, the neural network can be trained to generate a comprehensible and/or converging solution—i.e. structural parameters for the complex apparatus over multiple design iterations, the respectively corresponding operating parameters of which are increasingly consistent with the at least one specification parameter as the design iteration progresses.

In some embodiments in which an error magnitude is determined, the training of the neural network is carried out by a back-propagation algorithm and the error magnitude is minimized. In this advantageous manner, fast convergence can be achieved on the basis of the error magnitude and/or the error magnitude can be used to also include different criteria for training the neural network—in particular in weighted form.

In some embodiments, the reference data are stored in an ontologically structured database.

In some embodiments, an initial design for at least one complex apparatus from the multiplicity of complex apparatuses is stored in an ontologically structured database.

An advantage of an ontologically structured database and the storage of the reference data, the operating data and/or an initial design therein may be in particular that the applicable data can be stored in a structured form such that an efficient (similarity) search for specific categories of complex apparatuses, specification parameters, structural parameters and/or operating parameters over the ontologically structured database is rendered possible.

In some embodiments in which the reference data and/or the operating data are stored in an ontologically structured database, the method furthermore comprises storing the reference data and/or the operating data in the ontologically structured database. In some advantageous variants, it is possible, in particular for the purpose of setting up the ontology, for a sensitivity analysis in regard to one of the structural parameters and/or in regard to a specification parameter to be performed, so that the structural parameters and/or the specification parameters on which specific operating parameters are particularly dependent, or accordingly vice versa, is/are determined.

In some embodiments in which the reference data and/or the operating data are stored in an ontologically structured database, the method comprises retrieving the reference data, for the purpose of providing them, and/or retrieving the operating data, for the purpose of providing them, from the ontologically structured database.

An advantage of storing an initial design in an ontologically structured database may be in particular that this initial design can be retrieved from the ontologically structured database for a similar design, in particular on the basis of a similarity search in the ontologically structured database. In some advantageous variants the initial design is then ruled out as a direct solution, but the neural network is used to determine a solution, in particular on the basis of the initial design.

In some embodiments in which an initial design is stored in an ontologically structured database, the method may furthermore comprise determining an initial design of the complex apparatus from the at least one specification parameter on the basis of a similarity search over the ontologically structured database. Moreover, in such embodiments, the training of the neural network is additionally based on the initial design of the complex apparatus and/or on the initial design of the at least one complex apparatus. Finally, the generating of the structural parameters of the complex apparatus additionally takes the initial design of the complex apparatus as a starting point. An advantage of the training and generating on the basis of and/or starting from the initial design may be in particular that the structural parameters of the complex apparatus can be generated efficiently, i.e. with lower processing power, and/or—in particular in the case of neural methods that perform local optimization—a solution, i.e. structural parameters of the complex apparatus that are situated in a local area for similar complex apparatuses that is stipulated by the initial design are determined.

A second aspect of embodiments of the invention relate to a system for generating structural parameters of a complex apparatus from at least one specification parameter. The system has a neural network and a data processing apparatus. Moreover, the system has one or more data interfaces for receiving reference data that denote a multiplicity of complex apparatuses and the respective at least one specification parameter thereof and also in each case structural parameters, and for receiving operating data that denote the multiplicity of complex apparatuses and the respective operating parameters thereof that correspond to the respective structural parameters. The data processing apparatus is configured to receive the reference data and the operating data by one of the data interfaces. Moreover, the data processing apparatus is configured to train the neural network on the basis of the reference data and the operating data. Finally, the data processing apparatus is configured to generate the structural parameters of the complex apparatus from the at least one specification parameter and by the trained neural network.

The possible advantages, embodiments or variants already mentioned above for the first aspect of embodiments of the invention also apply accordingly to the system according to embodiments of the invention.

In some embodiments, the data processing apparatus is also configured to implement the neural network. To this end, in some variants, the data processing apparatus can have a program containing computer-readable instructions that, when executed on the data processing apparatus, prompt the latter to perform the calculations consistent with a neural network. In this advantageous manner, the neural network can be implemented using a commercially available computer.

In some embodiments, the system has a further data processing apparatus that is specifically configured to perform the calculations of a neural network. In some variants, this further data processing apparatus may be a neuromorphic processor, neural processor or a neurosynaptic processor—or else “neuroprocessor” for short—such as for example a system having one or more TrueNorth processors from IBM. In this advantageous manner, the neural network can be implemented particularly efficiently, that is to say in particular with high processing speed and/or low power consumption or resource requirement.

In some embodiments, one of the data interfaces is in the form of a network interface, which means that the reference data and/or the operating data can be received—for example from the Internet—via a network.

In some embodiments, the system has a data storage apparatus configured to store the reference data and/or the operating data. In some advantageous variants, one of the data interfaces may be in the form of an internal data interface between the data storage apparatus and the data processing apparatus, so that the reference data and/or the operating data can be received and/or provided by this internal data interface.

A third aspect of embodiments of the invention relate to a computer program product for generating structural parameters of a complex apparatus from at least one specification parameter. The computer program product has or provides computer-readable instructions, wherein the computer-readable instructions, when executed on a data processing apparatus, prompt the latter to train a neural network on the basis of reference data and operating data and also to generate the structural parameters of the complex apparatus from the at least one specification parameter and by the trained neural network. The reference data denote a multiplicity of complex apparatuses and the respective at least one specification parameter thereof and also in each case structural parameters. The operating data denote the multiplicity of complex apparatuses and the respective operating parameters thereof that correspond to the respective structural parameters.

The possible advantages, embodiments or variants already mentioned above for the preceding aspects of the invention also apply accordingly to the computer program product according to embodiments of the invention for generating structural parameters.

In some embodiments, the computer program product is in the form of a data carrier to which corresponding computer-readable instructions have been written.

Alternatively, in some embodiments, the computer program product is in the form of a, virtual, computer network configured to provide the computer-readable data. In some variants, the computer-readable data may be stored on a data carrier. Alternatively or additionally, the computer network may, in some variants, be advantageously configured to generate, and thus provide, the computer-readable instructions, on the basis of a text-based description of the program—source code—or on the basis of multiple data elements—distributed data segments, for example of a peer-to-peer network such as BitTorrent—using an algorithm.

Further advantages, features and opportunities for application will emerge from the detailed description of exemplary embodiments that follows and/or from the figures.

### BRIEF DESCRIPTION

Some of the embodiments will be described in detail, with references to the following Figures, wherein like designations denote like members, wherein:

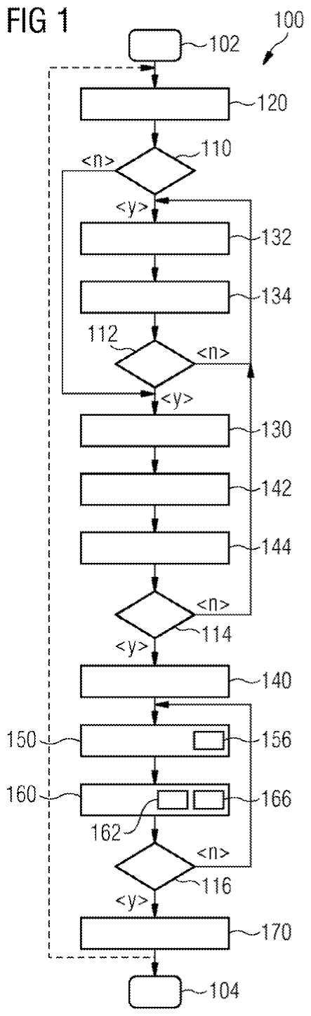

FIG. 1 shows a flowchart for a computer-aided method for generating structural parameters of a complex apparatus from at least one specification parameter according to an embodiment; and

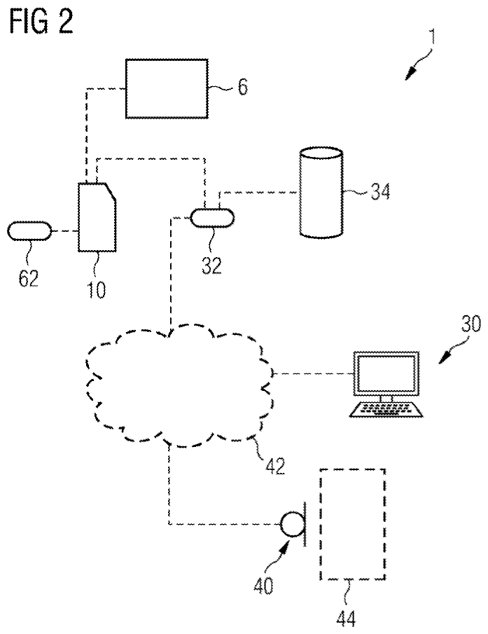

FIG. 2 shows a system for generating structural parameters of a complex apparatus from at least one specification parameter according to an embodiment.

### DETAILED DESCRIPTION

The figures are schematic depictions of different embodiments and/or exemplary embodiments of the present invention. Elements and/or components depicted in the figures are not necessarily depicted to scale. On the contrary, the different elements and/or components depicted in the figures are reproduced such that their function and/or purpose become comprehensible to a person skilled in the art.

Connections and couplings depicted in the figures between functional units and elements can also be implemented as indirect connections or couplings. Data connections may be in wired or wireless form, that is to say in the form of a radio connection. Specific connections, for example electrical connections, for example for supplying power, may also not be depicted for the sake of clarity.

FIG. 1 uses a flowchart to illustrate a computer-aided method 100 for generating structural parameters of a complex apparatus from at least one specification parameter according to an embodiment of the present invention. The structural parameters of the complex apparatus are generated by a neural network in this case.

In one exemplary embodiment the method 100 has the method steps 120, 130, 132, 134, 140, 142, 144, 150, 156, 160, 162, 166 and 170 and also the process conditions 110, 112, 114 and 116. The method 100 begins at the method start 102 and ends at the method end 104, one or more method steps, a sequence of method steps, and the whole method 100 being able to be carried out repeatedly.

In method step 120, the at least one specification parameter is provided. To this end, the specification parameter can be read in via a user interface in some variants. This at least one specification parameter can also advantageously be extracted from details from the user and/or a description by a customer for the desired complex apparatus on the basis of natural language processing. It goes without saying that further specification parameters of this kind for the complex apparatus can also be provided and extracted and/or the method, the generating of the structural parameters of the complex apparatus, can also take these further specification parameters as a starting point.

In order to provide reference data in method step 130 and/or to provide operating data in method step 140, the process condition 110 involves a test to determine whether the reference data or operating data do not yet comprise a multiplicity of complex apparatuses and/or whether at least one complex apparatus is supposed to be added for the multiplicity of complex apparatuses.

If the reference data or operating data are supposed to have the at least one complex apparatus added, that is to say data regarding the at least one complex apparatus are supposed to be added or freshly included—which is symbolized by <y> at process condition 110 in the flowchart—then method step 132 involves one or more manual design iterations for this at least one complex apparatus being monitored, the aim of the manual design iterations being to reach the at least one specification parameter of this at least one complex apparatus.

In some variants, a person skilled in the art in the respective field of the respective complex apparatus to be constructed adapts one or more structural parameters of the complex apparatus such that the at least one specification parameter of this at least one complex apparatus is reached or at least approached.

In some variants, for every change in the structural parameters, not just the at least one specification parameter can change but rather—on the basis of complex functional relationships between the structural parameters and specification parameters—a multiplicity of specification parameters can change.

In method step 134, the structural parameters of this at least one complex apparatus and its change are recorded for every manual design iteration and the reference data for this at least one complex apparatus, which is therefore one of the complex apparatuses from the multiplicity of complex apparatuses, are adapted so that the reference data for this at least one complex apparatus comprise the structural parameters for every manual design iteration.

In an alternative variant to performing method steps 132 and 134, the method can also be aborted or terminated without a solution after the process condition 110 if sufficient reference data or operating data are not available.

The process condition 112 involves a test to determine whether the at least one specification parameter of the at least one complex apparatus has already been reached on the basis of the structural parameters of the preceding manual design iteration and/or the manual design process needs to be terminated—for example because a further check on the design, by simulation, could be required or a predetermined maximum number of design iterations has been reached. If the manual design process needs to be continued, i.e. a further manual design iteration needs to be carried out, and/or the at least one specification parameter of this at least one complex apparatus has not yet been reached—which is symbolized by <n> at the process condition 112 in the flowchart—then method step 132 is carried out again, so that an iterative method, that is to say an iterative design process having multiple manual design iterations, is obtained.

If the manual design process needs to be terminated and/or the at least one specification parameter of this at least one complex apparatus from the multiplicity of complex apparatuses has been reached—which is symbolized by <y> at process condition 112 in the flowchart—then method step 130 involves the (adapted) reference data being provided that denote the multiplicity of complex apparatuses and the respective at least one specification parameter thereof and also in each case structural parameters.

Alternatively or additionally, in some variants, the method 100 can also be carried out concurrently with the manual design process and the further method steps 130, 142ff so that the reference data are adapted by the manual design process and are provided for the further steps at the same time—even without reaching the at least one specification parameter—and in method step 130.

The recording of the structural parameters for every manual design iteration—irrespective of whether the respective iteration has reached or at least come closer to the at least one specification parameter—allows the neural network to be trained with each of these iteration steps, so that faster convergence can be achieved in comparison with only partial recording.

In method step 142, the at least one complex apparatus is simulated for every manual design iteration and on the basis of the respective structural parameters to determine its respective operating parameters.

In method step 144, the operating data at least for this at least one complex apparatus are adapted and the operating parameters that have been determined by the simulation are stored for every manual design iteration and therefore the operating data are adapted.

The process condition 114 involves a test to determine whether the at least one specification parameter of this at least one complex apparatus has been reached on the basis of the operating parameters from the preceding simulation with the structural parameters of the preceding design iteration for this at least one complex apparatus. If this is not the case—which is symbolized by <n> at process condition 114 in the flowchart—then the method is continued again and hence iteratively at method step 132.

In some advantageous variants, a criterion for reaching the at least one specification parameter is that the at least one specification parameter is situated within a tolerance band, that is to say is situated between a predetermined minimum value and maximum value. If multiple specification parameters—such as customer requirements, short-circuit strength or values on the basis of standards—need to be reached, such variants allow an applicable criterion to be applied to each of the specification parameters.

If the at least one specification parameter of the at least one complex apparatus has been reached according to the simulated operating parameters—which is symbolized by <y> at process conditions 114 in the flowchart—then method step 140 involves the operating data being provided, which may have been adapted accordingly, and which denote the multiplicity of complex apparatuses and the respective operating parameters thereof that correspond to the respective structural parameters.

In some advantageous variants, the reference data and the operating data may be stored in an ontologically structured database and can be stored there in method steps 134 and 144, for example, and retrieved from the ontologically structured database for method steps 130 and 140.

If at least one complex apparatus is not supposed to be added for the multiplicity of complex apparatuses—which is symbolized by <n> at process conditions 110 in the flowchart—then the method is continued at method step 130, wherein, in some variants, if sufficient operating parameters are not available for the operating data, the operating parameters are determined in method steps 142 and 144 and the operating data are adapted accordingly. In other variants—not depicted—the method can be continued at method step 150, wherein the reference data and the operating data are provided.

Iteratively, the neural network is trained in method step 150 and the structural parameters of the complex apparatus are generated in method step 160. The method is iteratively carried out further until, according to process condition 116, adequate training of the neural network has been achieved and/or a predetermined maximum number of iterations has been reached which is symbolized by <y> at process condition 160 in the flowchart.

Specifically, the following is carried out in this regard in some advantageous variants.

In method step 150, the neural network is trained at least on the basis of the reference data and the operating data.

In method step 156, which, as depicted, may be part of method step 150, to rate the training result and/or for the next iteration of the training, an error magnitude is determined that comprises the divergence between the structural parameters of the reference data and structural parameters determined by the neural network and also the divergence between the respective at least one specification parameter and respective operating parameters that correspond to the structural parameters determined by the neural network.

In method step 160, the structural parameters of the complex apparatus are generated from the at least one specification parameter and by the trained neural network. In some variants—not depicted—the starting point taken for generating the structural parameters can be an initial design that is determined in a further method step, by a similarity search over the ontologically structured database.

In method step 162, the complex apparatus is simulated on the basis of the generated structural parameters to determine operating parameters of the complex apparatus. This method step, as depicted, may be part of method step 160.

In method step 166, which, as depicted, may be part of method step 160, the divergence between the at least one specification parameter and the operating parameters—determined by the simulation—is determined, wherein the error magnitude also comprises this divergence.

In some advantageous variants, the neural network may be configured not only to determine the structural parameters of the complex apparatus as (final values of the) structural parameters, but rather to determine the structural parameters of the complex apparatus for multiple design iterations and from the at least one specification parameter of the complex apparatus.

Accordingly, during training, the neural network respectively determines the structural parameters for every design iteration for the at least one complex apparatus from the multiplicity of complex apparatuses in method step 150 and the neural network respectively generates the structural parameters for every design iteration for the complex apparatus—that is to be designed—in method step 160. In this manner, the design process can advantageously be comprehended by a person skilled in the art, which means that the neural network also generates and/or optimizes structural parameters for a series of design iterations.

During determination of the error magnitude in method step 156, in some advantageous variants the divergences between the structural parameters of the reference data and structural parameters determined by the neural network are furthermore determined in each case for each design iteration for the at least one complex apparatus for which the manual design iterations have been monitored, wherein the error magnitude also comprises these divergences. Moreover, in some advantageous variants in method step 156, which have involved the operating parameters for the at least one complex apparatus being simulated for every manual design iteration, the divergences between the at least one specification parameter of this at least one complex apparatus and the respective operating parameters for the respective design iteration can be determined for every design iteration for this at least one complex apparatus, wherein the error magnitude also comprises these divergences.

Process condition 116 involves a test to determine whether the neural network has been adequately trained, i.e. whether the error magnitude is situated in a predetermined range. If this is not the case, that is to say for example the error that the neural network makes during training is still too large—which is symbolized by <n> at process condition 116 in the flowchart—then the method is continued in method step 150.

Otherwise, that is to say if the neural network is adequately trained or if a specific number of maximum iterations has been exceeded—which is symbolized by <y> at process condition 116 in the flowchart—then method step 170 involves the generated structural parameters being output. The specific number of maximum iterations can be exceeded if an adequately trained neural network has not been obtained by the time the maximum iterations are reached. This additional or alternative condition allows training times of indefinite length to be avoided and/or the method to be continued even if the neural network is not yet adequately trained, which means that at least one, albeit possibly not optimum, solution can be achieved.

FIG. 2 schematically depicts a system 1 for generating structural parameters of a complex apparatus from at least one specification parameter according to an embodiment of the present invention.

In one exemplary embodiment the system 1 has a neural network 6, a data processing apparatus 10, multiple data interfaces 32, 62 and a data storage apparatus 34. The system 1 is configured to carry out a method for generating structural parameters according to an embodiment of the present invention and a method 100 according to an embodiment for FIG. 1. In this regard, in an advantageous variant, the system 1 can comprise a computer program product according to an embodiment of the present invention and/or the data processing apparatus 10 may be configured, by computer-readable instructions that the computer program product comprises or provides, to carry out a corresponding method.

In one exemplary embodiment the system 1 also has a monitoring apparatus 30 configured to monitor manual design iterations for designing at least one complex apparatus, wherein in some variants the monitoring apparatus 30 may be in the form of a commercially available computer on which software for designing corresponding complex apparatuses is installed. Such a monitoring apparatus 30 can be used by a person skilled in the art to design corresponding complex apparatuses. The inputs by the person skilled in the art, that is to say the input structural parameters for the respective complex apparatus, are recorded in this case.

In one exemplary embodiment the system 1 furthermore has a sensor system 40 configured to capture operating parameters from at least one complex apparatus.

As depicted in FIG. 2, the at least one complex apparatus 44 may be a part of the system 1 in some variants, whereas it is external to the system in other variants of the system 1. The sensor system 40 is configured to capture the operating parameters of the complex apparatus 44. In some advantageous variants such capture can take place in a test environment or continually during operation of the complex apparatus.

In some variants the sensor system 40 can comprise a temperature sensor, a microphone, a voltage sensor or a load sensor.

In some variants the sensor system 40 may also be configured to capture temperatures, voltages, electric powers or loads, specific chemical compounds or noise and/or to perform what is known as an “oil in gas” analysis, implementation monitoring, load flow monitoring, performance measurement in regard to electric powers, or partial discharge measurement.

FIG. 2 also symbolizes the Internet 42, this not being part of the system 1. Different components of the system 1 may be connected via the Internet 42 for data transmission purposes, however.

In some variants the data interface 32 in conjunction with the data processing apparatus 10 and the data storage apparatus 34 is configured to receive the reference data from the monitoring apparatus 30, via the Internet 42, and to receive the operating data likewise from the monitoring apparatus 30 and/or from the sensor system 40, via the Internet 42.

In some variants the data processing apparatus 10 is configured to store the reference data and the operating data in an ontologically structured database on the data storage apparatus 34.

In one exemplary embodiment the data storage apparatus 10 is also configured so as, after the training of the neural network 6 and the generation of the structural parameters of the complex apparatus on the basis of the at least one specification parameter, to output the generated structural parameters by the data interface 62. In some variants the data interface 62 may be in the form of a user interface or in the form of a network interface.

In some variants the data processing apparatus 10 may be in the form of a commercially available computer. Alternatively, in some variants the data processing apparatus 10 and the data storage apparatus 34 and also an implementation of the neural network 6 may be in the form of a distributed computer, for example in the form of a server cluster, and more advantageously in virtualized form.

In some variants the data processing apparatus 10 can comprise suitable programming for the neural network 6,—for example a multilayer neural network for back-propagation. In some advantageous variants the system 1 can also comprise specific hardware for neural networks—for example what is known as a neuroprocessor—that allows particularly efficient processing of neural algorithms of this kind.

In some variants it should be borne in mind that a transformer normally has to undergo tests according to a standard. Typical measurements in a test environment comprise:
open-circuit losses,
load losses,
short-circuit impedance,
ratio errors,
cooling behavior,
noise emission, and
insulation resistance with test voltages.

The sensor system 40 may advantageously be configured for one or more of these measurements.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-aided method for generating structural parameters of a complex apparatus from at least one stipulated specification parameter by a neural network, wherein the method comprises:
providing reference data that denote a multiplicity of complex apparatuses and the respective at least one specification parameter thereof and also in each case structural parameters, wherein the respective structural parameter characterizes at least one part of the structure of the respective complex apparatus;
providing operating data that denote the multiplicity of complex apparatuses and the respective operating parameters thereof that correspond to the respective structural parameters and characterize at least one part of the respective complex apparatus during its operation or the operation thereof;
training the neural network on the basis of the reference data and the operating data; and
generating the structural parameters of the complex apparatus from the at least one specification parameter and by the trained neural network, wherein the structural parameters are generated for producing the complex apparatus and the complex apparatus is constructed on the basis of these structural parameters;
wherein the respective at least one specification parameter is a stipulation for the respective operating parameters and the operating parameters comply with this respective specification parameter; and
wherein during training an error magnitude is determined that comprises the divergence between the structural parameters of the reference data and structural parameters determined by neural network and also the divergence between the respective at least one specification parameter and respective operating parameters that correspond to the structural parameters determined by the neural network.

2. The computer-aided method as claimed in claim 1, which furthermore comprises:
monitoring manual design iterations of at least one complex apparatus from the multiplicity of complex apparatuses for reaching the at least one specification parameter of this at least one complex apparatus, wherein the manual design iterations need to be performed to reach the at least one specification parameter;
adapting the reference data, wherein the structural parameters for this at least one complex apparatus are stored for every manual design iteration; and
adapting the operating data, wherein the operating parameters for this at least one complex apparatus are stored for every manual design iteration;
and wherein the neural network is trained on the basis of these adapted reference data and operating data.

3. The computer-aided method as claimed in claim 1, furthermore comprising simulating the complex apparatus on the basis of the generated structural parameters to determine operating parameters of the complex apparatus; and wherein the training of the neural network is moreover based on the at least one specification parameter and the operating parameters of the complex apparatus.

4. The computer-aided method as claimed in claim 3, wherein the training of the neural network is carried out iteratively while respectively simulating the complex apparatus on the basis of the respectively generated structural parameters.

5. The computer-aided method as claimed in claim 1, furthermore comprising:
simulating at least one complex apparatus from the multiplicity of complex apparatuses to determine its operating parameters for providing or adapting the operating data.

6. The computer-aided method as claimed in claim 1, wherein the operating data for at least one complex apparatus from the multiplicity of complex apparatuses are provided by virtue of the operating parameters being received from a sensor system configured to measure the operating parameters of this at least one complex apparatus.

7. The computer-aided method as claimed in claim 6, furthermore comprising:
measuring the operating parameters of this at least one complex apparatus by the sensor system.

8. The computer-aided method as claimed in claim 1, wherein:
the reference data for at least one complex apparatus from the multiplicity of complex apparatuses respectively denote structural parameters for every design iteration for multiple design iterations for reaching the at least one specification parameter;
the operating data for this at least one complex apparatus respectively denote operating parameters for every design iteration that correspond to the structural parameters for this at least one complex apparatus and for the respective design iteration;
the neural network is configured to respectively determine the structural parameters for multiple design iterations from the at least one specification parameter of this at least one complex apparatus; and
during determination of the error magnitude the divergences between the structural parameters of the reference data and structural parameters determined by the neural network are furthermore determined for every design iteration for this at least one complex apparatus, and the error magnitude comprises these divergences.

9. The computer-aided method as claimed in claim 8, furthermore comprising simulating the at least one complex apparatus for every design iteration and on the basis of the respective structural parameters to determine its respective operating parameters for providing or for adapting the operating data; and wherein during determination of the error magnitude the divergences between the at least one specification parameter of this at least one complex apparatus and the respective operating parameters for the respective design iteration are furthermore determined for every design iteration for this at least one complex apparatus, and the error magnitude comprises these divergences.

10. The computer-aided method as claimed in claim 1, wherein:
the neural network is configured to generate the structural parameters of the complex apparatus from the at least one specification parameter of the complex apparatus for every design iteration from multiple design iterations;
the respective operating parameters of the complex apparatus are simulated for every design iteration; and
during determination of the error magnitude the divergence between the at least one specification parameter and the respective operating parameters is furthermore determined for every design iteration, and the error magnitude comprises these divergences.

11. The computer-aided method as claimed in claim 1, wherein the training is carried out by a back-propagation algorithm and the error magnitude is minimized.

12. The computer-aided method as claimed in claim 1, wherein:
an ontologically structured database stores at least one of the reference data, the operating data and stores an initial design for at least one complex apparatus from the multiplicity of complex apparatuses;
the method furthermore comprises determining an initial design of the complex apparatus from the at least one specification parameter on the basis of a similarity search over the ontologically structured database;
and wherein:
at leaset one of the training of the neural network is also based on at least one of the initial design of the complex apparatus and on the initial design of the at least one complex apparatus; and
the generating of the structural parameters of the complex apparatus additionally takes the initial design of the complex apparatus as a starting point.

13. A system for generating structural parameters of a complex apparatus from at least one stipulated specification parameter, wherein the structural parameters are generated for producing the complex apparatus and the complex apparatus is constructed on the basis of these structural parameters, wherein the system has:
a neural network;
a data processing apparatus; and
one or more data interfaces for receiving reference data that denote a multiplicity of complex apparatuses and the respective at least one specification parameter thereof and also in each case structural parameters, and for receiving operating data that denote the multiplicity of complex apparatuses and the respective operating parameters thereof that correspond to the respective structural parameters;
and wherein the data processing apparatus is configured:
to receive the reference data and the operating data by one of the data interfaces;
to train the neural network on the basis of the reference data and the operating data; and
to generate the structural parameters of the complex apparatus from the at least one specification parameter and by the trained neural network; and
wherein during training an error magnitude is determined that comprises the divergence between the structural parameters of the reference data and structural parameters determined by the neural network and also the divergence between the respective at least one specification parameter and respective operating parameters that correspond to the structural parameters determined by the neural network.

14. A computer program product comprising a computer readable hardware storage device having computer readable program code stored therein, said program code executable by a processor of a computer system to implement a method for generating structural parameters of a complex apparatus from at least one stipulated specification parameter, wherein the structural parameters are generated for producing the complex apparatus and the complex apparatus is constructed on the basis of these structural parameters, wherein the computer program product has or provides computer-readable instructions that, when executed on a data processing apparatus, prompt the latter to train a neural network on the basis of reference data and operating data and also to generate the structural parameters of the complex apparatus from the at least one specification parameter and by the trained neural network, wherein the reference data denote a multiplicity of complex apparatuses and the respective at least one specification parameter thereof and also in each case structural parameters, and wherein the operating data denote the multiplicity of complex apparatuses and the respective operating parameters thereof that correspond to the respective structural parameters; wherein during training an error magnitude is determined that comprises the divergence between the structural parameters of the reference data and structural parameters determined by the neural network and also the divergence between the respective at least one specification parameter and respective operating parameters that correspond to the structural parameters determined by the neural network.
